(19) United States
(12) Patent Application Publication
(10) Pub. No.: US 2003/0094711 A1
(43) Pub. Date: May 22, 2003

(54) Device for producing a gas mixture

(76) Inventors: Rodney Moore, Gardener, MA (US); Andreas Henkel-Luttringhaus, Darmstadt (DE); Patrik Hoffmann, Epalinges (CH)

Correspondence Address: John F Mcnulty, Paul & Paul, 2900 Two Thousand Market Street, Philadelphia, PA, 19103, US

(21) Appl. No.: 10/149,924

(22) PCT Filed: Dec. 14, 2000
(86) PCT No.: PCT/EP00/12493

(30) Foreign Application Priority Data
Dec. 15, 1999 (DE) 19960333.2

(51) Int. Cl. B01F 3/04

(52) U.S. Cl. 261/97

(57) ABSTRACT

The invention relates to a device for producing a gas mixture consisting of HMDSO and oxygen, whereby process gas is produced. In order to be able to continuously produce a large volume of process gas using such a device and to be able to withdraw the same at practical processable temperatures, the invention provides that a number of filling packages (2) are stacked in an elongated essentially vertical column (1) that can be cooled. In addition, an inlet tube (3), which is inserted into the column (1) from the exterior, and a gas outlet connection (6), which leads to the exterior, are secured in the upper area of said column (1). Devices (26) are also provided for measuring the temperature, the pressure and the amount of the exiting gas mixture. In addition, a distribution cup (29) which spans the cross-section of the column (1) and which is provided with gas flow-through openings (38) is placed underneath the inner discharge end (4) of the inlet tube (3).

The invention concerns an apparatus for producing a gas mixture of a liquid educt compound, for example HMDSO, and a carrier gas, for example oxygen (O₂), as a process gas.

It is known to treat workpieces by plasma coating processes, wherein a gas mixture comprising a liquid educt compound and a carrier gas, as for example hexamethyldisiloxane (HMDSO) and oxygen, is used to produce the plasma. Apparatuses of the kind set forth in the opening part of this specification have already been built for such coating processes in order to coat for example optical lenses. In such apparatuses, primarily the liquid HMDSO was heated and the vapour which was produced in that operation mixed with oxygen so that the desired gas mixture was available as a process gas. The boiling temperature of the HMDSO is approximately the same as that of water, and therefore the gas mixture produced suffered from the disadvantage of involving a temperature of the order of magnitude of 100° C., with the disadvantage that it partially condensed in the gas-carrying lines and conduits up to the equipment for plasma production. The attempt has been made to bring that gas loss under control by heating the gas-carrying lines or conduits, including the valves, distributors and the like. It will be appreciated however that such an apparatus is complicated and expensive and can be technically implemented only with difficulty.

Therefore the object of the present invention is to provide an apparatus of the kind set forth in the opening part of this specification, with which a large volume of process gas can be continuously produced and can be taken off at practically workable temperatures. Practical workable temperatures presuppose a product gas (gas mixture) which is presented in the order of magnitude of ambient temperature, in which respect temperatures of the gas mixture of between 0° C. and 20° C. are also deemed to be practically workable. A further condition for the way of attaining the object in accordance with the invention was the provision of a gas flow involving a large volume per unit of time, in which respect consideration is given here to between 0.05 and 5 m³ per hour and preferably between 0.1 and 0.5 m³ per hour and most preferred between 0.2 and 0.5 m³ per hour (the volume flow is converted to standard conditions—1 bar pressure, 20° C.—).

In accordance with the invention that object is attained in that a plurality of filling packings are arranged in mutually superposed relationship in an elongate, substantially vertically arranged, coolable column, that fixed in the upper region of the column are a feed connection portion which is passed from the exterior into the column and a gas outlet connection which is passed outwardly, and that there are provided devices for measuring the temperature, the pressure and the amount of the issuing gas mixture. As a liquid educt compound for producing a gas mixture together with a carrier gas in the apparatus of the present invention HMDSO is most preferred. Hence, it could be shown that the apparatus of the present invention is also useful for producing a gas mixture of multiple other liquid educt compounds and a carrier gas.

The liquid educt compounds typically used for producing a plasma comprise a metal or a semi metal, as for example tin, zinc, silicon, zirconium, titanium or aluminium. The compounds are organic compounds or organo-metallic compounds, like alcoxides, acetates, alcyles or aryles. Preferably silicon-organic compounds are used, like tetramethoxisilane. Especilly preferred are tetramethyldisiloxane or silazanes, like hexamethyidisilazane. A number of educt compounds further useful in the present invention is disclosed in U.S. Pat. No. 5,041,303.

All references herein to the preferred educt compound HMDSO have to be understood exemplary and are also applicable to the aforementioned liquid educt compounds in the same manner or under compound specific modifications, which are known to the artisan skilled in this field.

The invention aimed to produce a vapour from the HMDSO at lower temperature. It was therefore necessary to provide for evaporation of the liquid HMDSO by means other than an increase in temperature. In order to provide such an evaporation apparatus, the invention makes use of distillation or extraction columns. Suitable modifications and measures were involved in order to evaporate at moderate temperatures the HMDSO which is introduced in a liquid condition at the top into a substantially vertically arranged column. In that respect the invention follows the path of using filling packings with a honeycomb structure, which are known per se from another context, whereby distribution of the liquid HMDSO is improved even at lower temperatures. The known filling packings with a honeycomb structure preferably comprise metal and are arranged in mutually superposed relationship in such a way that they are under a feed connection portion for the liquid HMDSO. If the feed connection portion terminates in the upper region of the column the flow of the liquid HMDSO can be converted into drops which drip onto the upper filling packing and which gradually pass under the effect of the force of gravity into the filling packings which are disposed therebeneath, where the large surface areas offered are wetted. The viscosity of the liquid HMDSO, which is approximately in the region of water, permits such distribution. In that respect, to maintain a constant ratio of HMDSO and carrier gas in the mixture, it is absolutely necessary to keep the temperature of the column constant. Particularly advantageous conditions are also involved if the column is cooled. In that respect, consideration has been given to a temperature of between 1° C. and 20° C. and preferably between 5° C. and 11° C. That can be implemented in technical terms by the column for example being provided with a cooling jacket through which coolant flows. The coolant itself—the use of water is particularly simple here—can then be temperature-controlled in a conventional thermostat.

It is desirable for the other gas, for example oxygen, which for example can also be replaced by argon, to be supplied in the lower region of the column. While the liquid components are moving towards the bottom of the column, the gaseous vapours are rising upwardly. In accordance with the invention, secured at a suitably advantageous location is a gas outlet connection which is passed outwardly and through which the desired gas mixture of HMDSO and a carrier gas, such as for example oxygen, is taken out of the column.

In addition, provided on or in the column according to the invention are devices for measuring the temperature and the pressure of the liquid and/or the gases or the gas mixture, because the gas mixture production process can be optimised by virtue of adjustment thereof. The same also applies in regard to the amount of the issuing gas mixture, which amount should be matched and adapted to the further working process to which however the other parameters within the production apparatus according to the invention must also be adapted.

The new production apparatus in accordance with the invention makes it possible to produce continuously a large volume flow of process gas, this occurring in particular at temperatures of the order of magnitude of ambient temperature, so that further processing and working, for example passing it through pipelines of relatively great length, through distributor devices and the like, is possible in a practical context and without involving technical difficulties.

In that respect it is desirable in accordance with the invention to connect to the bottom of the column a liquid sensor and a drain line, closable by a valve, for excess liquid. It has been found that, in use of the gas production apparatus according to the invention, in spite of the good distribution over the filling packings, a certain proportion of the HMDSO which is supplied in liquid form passes downwardly into the bottom region of the column and is no longer involved in any further evaporation. It is therefore advantageous to sense the presence and possibly also the amount of liquid at the bottom of the column and to drain off any excess liquid by actuation of a valve. That liquid can also be caught in a container or in a reprocessing installation so that, after the liquid HMDSO has passed through the apparatus a plurality of times, the largest possible proportion is converted into the vapour state.

It has proven to be practical for the column to be between about 15 cm and 1.5 m and preferably 30 cm in length. In that respect, the diameters involved are in the range of between 30 and 300, preferably between 40 and 200 and particularly preferably between 50 mm and 80 mm. Then between 2 and 10 and preferably between 3 and 8 filling packings of the honeycomb structure can be arranged in such columns in mutually superposed relationship.

In addition practical tests have shown that, with a greater and greater rise in the volume flow of the gas mixture produced, the amount of liquid HMDSO at the bottom of the column becomes greater. If there is a wish to supply very powerful machines with high volume flows of process gas of for example between 10 m³ and 20 m³ per hour, then the production flow of the new apparatus falls in the passage of time in the above-described manner below values of the production flow which no longer guarantee a supply for the powerful working machines.

It is admittedly obvious to increase the production output levels by constructing longer columns which are filled with a larger number of filling packings or in which more expensive filling packings with more honeycomb shape per unit of surface area are used. Such configurations are however expensive and susceptible to trouble due to the high level of technical complication and expenditure. Therefore for particularly high output levels the invention follows the different path of further designing the apparatus of the kind described hereinbefore, in such a way that disposed under the inner discharge end of the feed connection portion is a distributor bowl or cup which spans over the cross-section of the column and which has gas through-flow openings. It will be appreciated that such a distributor bowl must be gas-permeable for the amounts of vapour which rise from below and which are produced by the filling packings must be capable of rising upwardly through the distributor bowl. On the other hand with the arrangement of such a distributor bowl it is surprisingly possible for the relatively large drops of the liquid HMDSO, which occur at the discharge end of the feed connection portion, to be divided into or distributed as a considerably larger number of smaller drops. In order to maximise that distribution effect the distributor bowl is as large as possible. It spans over the cross-section of the column, in which respect however consideration is given to the required gas through-flow cross-section. The use of such a distributor bowl in the described apparatus according to the invention afforded the action that even large volumes of product gas mixture can be continuously produced, that is to say for example 100 m³ per hour, without it being possible to detect a fall in product, in the course of the production process; and that was the case at practically workable temperatures for the product gas mixture.

It is also advantageous in accordance with the invention if arranged in the central region of the distributor bowl is a central tray or plate portion which is provided with through holes and which is surrounded on the outside by the gas through-flow openings. In cross-section the column of the apparatus according to the invention is round because it is then easier to use the filling packings which are supplied industrially. The periphery of the distributor bowl which is of a flat or slightly curved configuration can then be desirably secured to the inside wall of the column so that the distributor bowl extends over the entire cross-section of the column. Then the above-mentioned central tray or plate portion is desirably provided only in the central region of the distributor bowl, the central tray or plate portion having through holes for the liquid HMDSO to pass therethrough. The free through-flow cross-section of the holes is between 1 and 20%, preferably between 5 and 10%, with respect to the closed surface area of the central tray or plate portion. In relation to the overall cross-section of the column the proportion of the surface area which is arranged externally around the central plate portion and which is predetermined by the gas through-flow openings is larger; for example, in the range of between 50 and 80% of the total column cross-section. It has been found that the liquid (HMDSO) which is supplied out of the feed connection portion drips onto the distributor bowl in the region of the central plate portion thereof and tries to pass downwardly into the upper-most filling packing through the individual through holes. As a result, the filling packing is already offered a flow of liquid which is distributed substantially better than in the first-mentioned apparatus without the distributor bowl.

In that respect it is desirable if in accordance with the invention the central plate portion of the distributor bowl is closed between the through holes and is carried by a central ring element. In its central region, the central plate portion which is fixed on the cylindrical internal surface of the column has the above-mentioned central ring element, within which the central plate portion is disposed. It is closed and open through the through holes respectively, in the above-mentioned percentage relationship. The production of such a distributor bowl is simple. The central plate portion can be curved towards the centre, in which respect a particularly desirable curvature is that in which the highest point of the central plate portion is in the middle region thereof. The central ring element can be connected by spoke-shaped connecting struts to an outer ring of the distributor bowl, which is secured to the inside wall of the column.

In an alternative embodiment of the invention the central plate portion is in the form of a sieve plate, the central plate portion also being supported by a central ring element. The sieve plate portion can be imagined as any suitable sieve of metal or plastic material, preferably sintered metal. It could also be in the form of a glass frit.

In accordance with the invention the apparatus of the kind described hereinbefore is particularly advantageous for coating the internal surfaces of hollow bodies. In particular hollow bodies which have only a single opening can be internally coated in that way if the desired gas mixture can be produced at the correct and practically workable temperature, introduced and, after its treatment and deposit thereof on the internal surface of the hollow body, the remaining process gas can be removed again.

Further advantages, features and possible uses of the invention will be apparent from the description hereinafter of preferred embodiments with reference to the drawings in which:

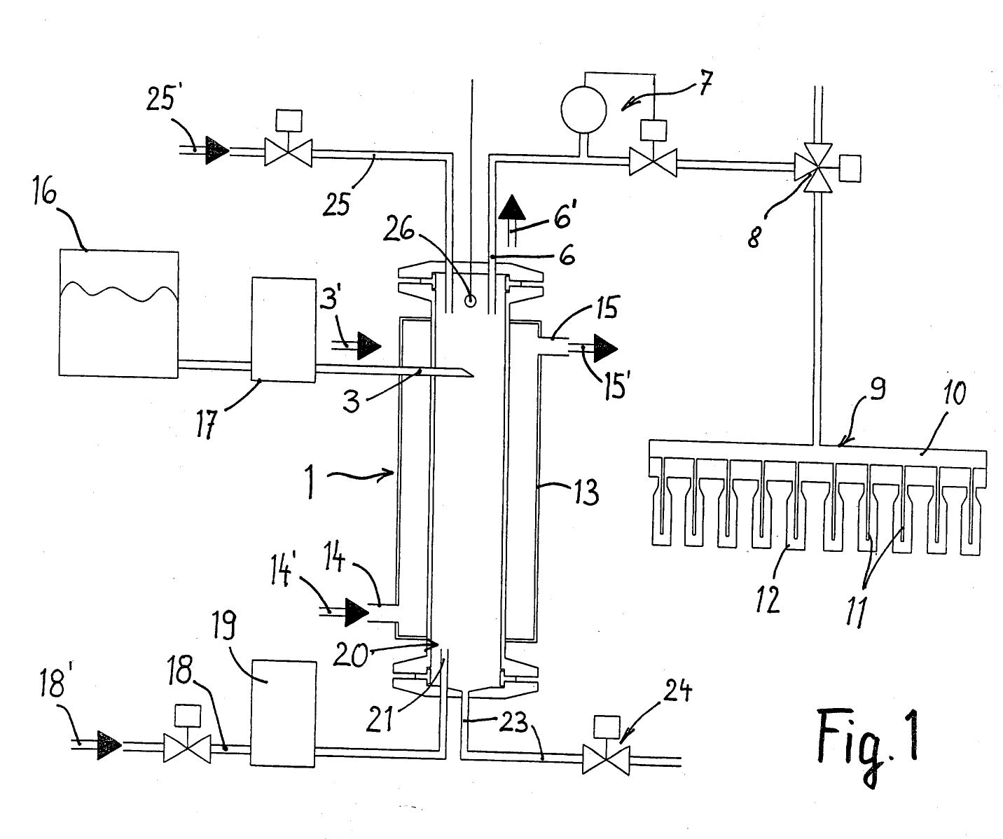

FIG. 1 is a diagrammatic view showing the principle of an overall system in which the apparatus for production of the gas mixture is diagrammatically illustrated in the centre,

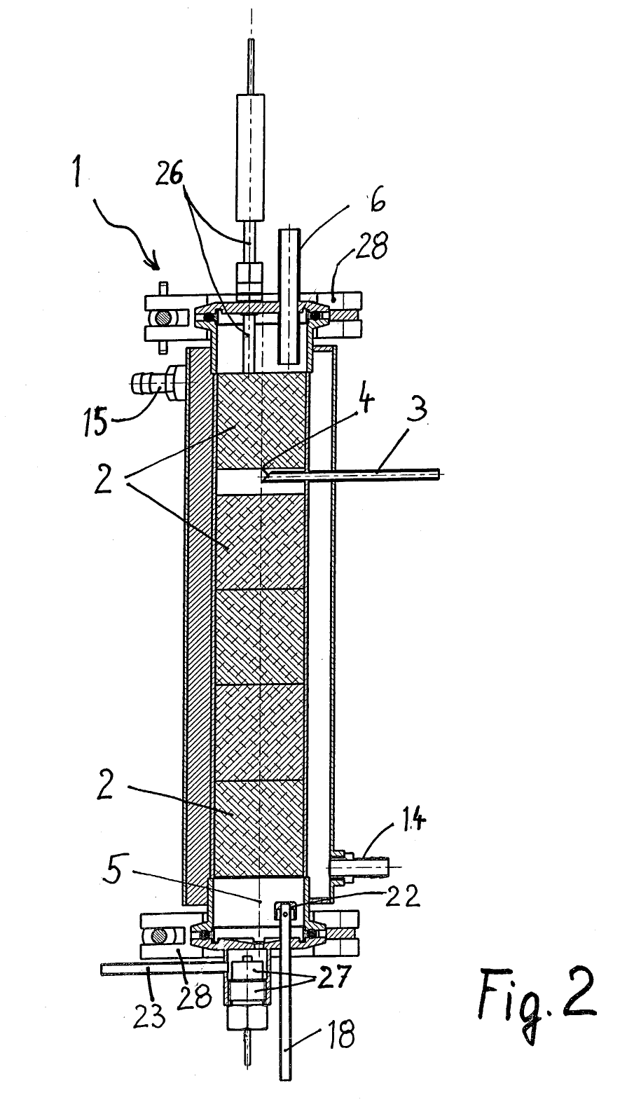

FIG. 2 is a view in cross-section through the column according to the invention without a distributor bowl,

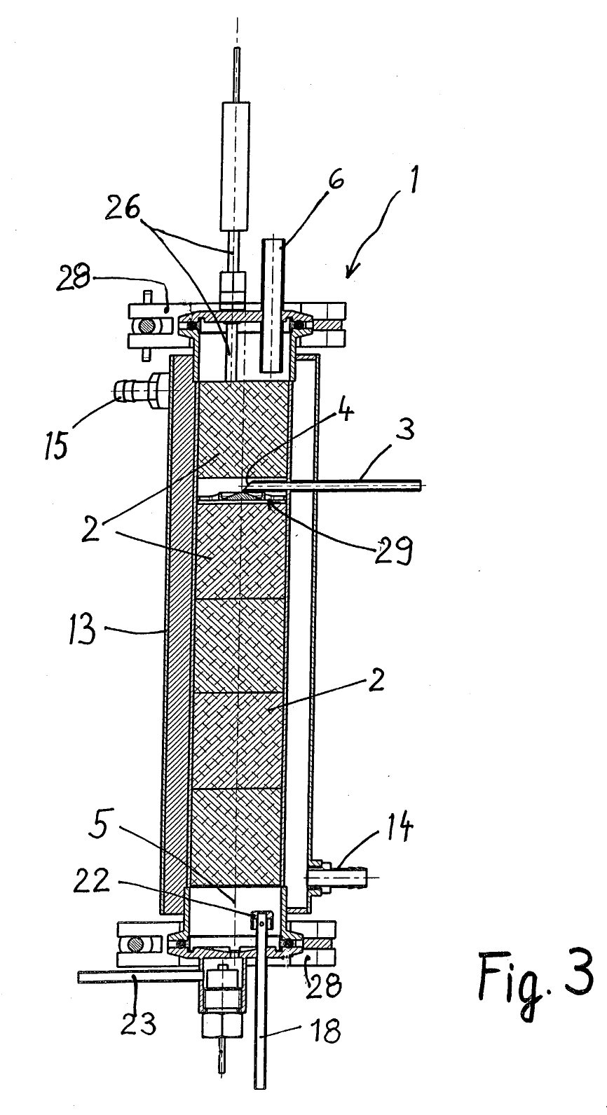

FIG. 3 is a view in cross-section through another embodiment of the column with a distributor bowl,

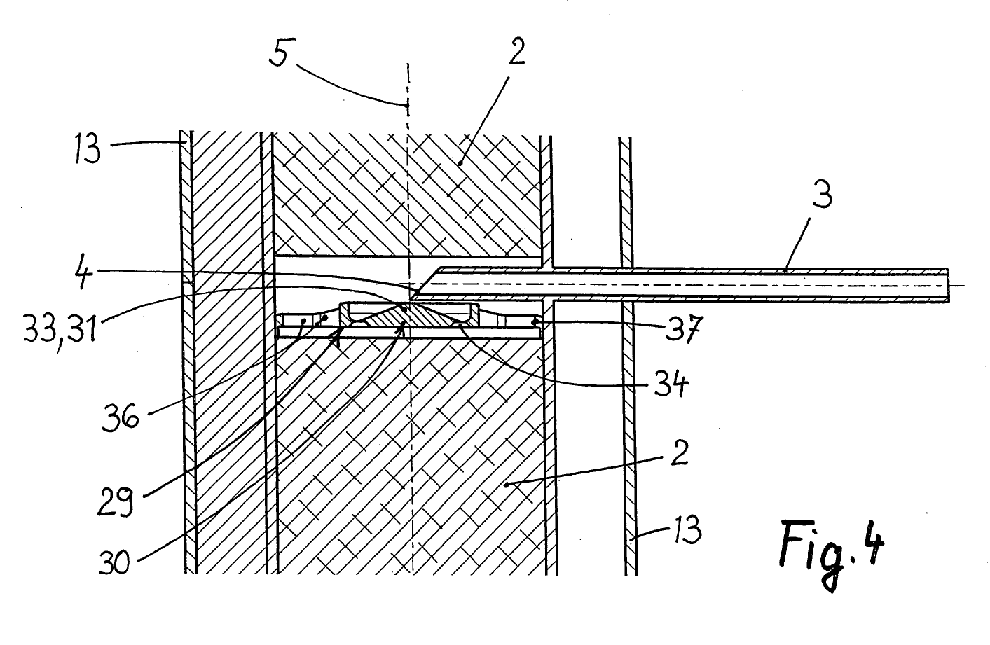

FIG. 4 is a view on an enlarged scale of a part of FIG. 3,

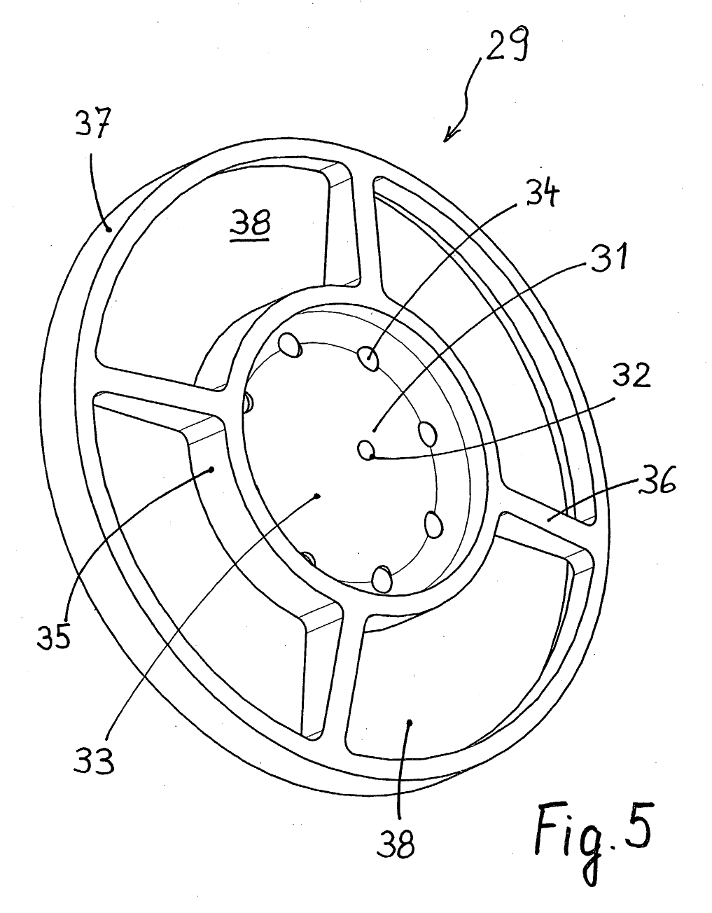

FIG. 5 is a perspective view of a distributor bowl with a closed central plate portion and through holes disposed therein, and

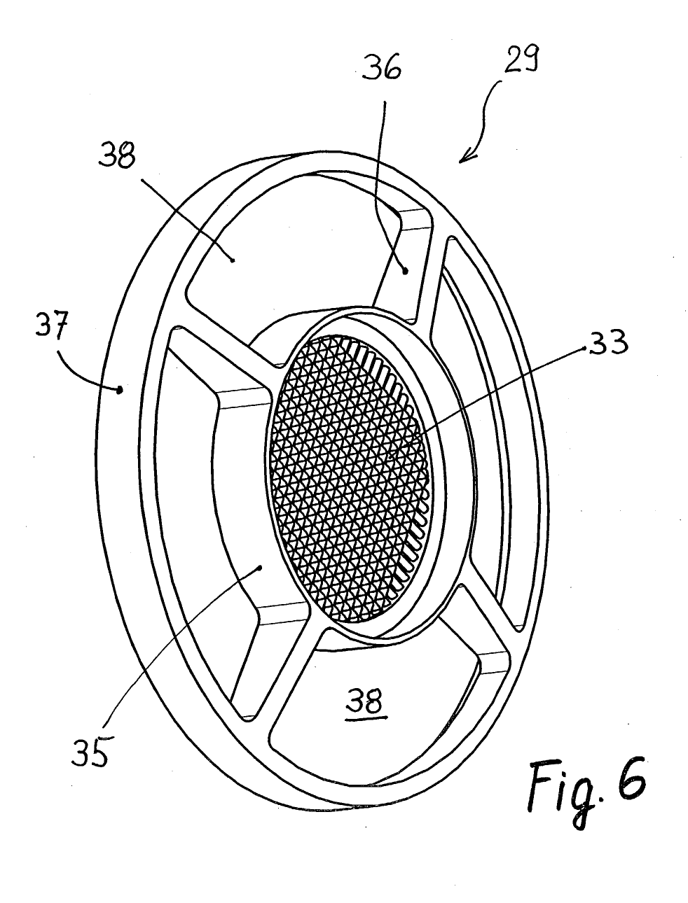

FIG. 6 shows a further embodiment of a distributor bowl with inserted sieve plate.

Referring to the diagrammatic view shown in FIG. 1 disposed approximately at the centre is the apparatus described herein for the production of the product gas mixture, generally identified by reference numeral 1. It represents the elongate, vertically arranged column 1 and is filled with five filling packings 2 which are each of a honeycomb structure and comprise a nickel-chromium-molybdenum alloy which is open to little chemical attack (trade name: Hastelloy). A feed connection portion 3 is introduced into the column from the exterior in the upper region of the column 1. The inward discharge end 4 of the feed connection portion 3 terminates approximately in the region of the vertical longitudinal centre line 5 of the column 1.

In FIG. 1 arrow 6′ denotes the direction of flow of the gas mixture produced, namely the process gas, which leave the column 1 at the top thereof through the gas outlet connection 6 which is passed outwardly. The process gas is a mixture of carrier gas and evaporated HMDSO and after passing through a pressure regulator 7 it passes by way of a valve 8 into the distribution system 9. In the preferred embodiment shown in FIG. 1 the distribution system 9 is a distributor 10 from which ten insertion lines 11 are inserted into the interior of hollow bodies, in this case bottles 12 which are open at the top.

The column 1 itself is coolable, that is to say it is externally enclosed by a cooling jacket 13 through which flows water as a cooling agent. It passes by way of the inlet 14 as indicated by the arrow 14′ from a thermostat into the hollow interior of the cooling jacket 13 and leaves same by way of the outlet 15 as indicated by the arrow 15′. In the production process implemented here the cooling water is maintained by the thermostat at a temperature in the range of between 5 and 11° C. The liquid HMDSO (hexamethyldisiloxane) is dripped into the column 1 by way of the feed connection portion 3 in the direction indicated by the arrow 3′ from the supply container 16 by way of the mass flow regulator 17. In the example shown in FIG. 1 the process gas is not solely evaporated HMDSO but a mixture with a carrier gas which here is oxygen (O₂) but which in other embodiments can also be argon (Ar), krypton (Kr) and the like. Oxygen as the carrier gas is also introduced into the bottom 20 of the column 1 through the introduction line 18 as indicated by the arrow 18′, and by way of the mass flow regulator 19. The downstream end of the gas introduction line 18 is shown in FIGS. 2 and 3 as being provided with a cap 22 which is provided to prevent liquid HMDSO from dripping into the gas introduction line 18.

Unevaporated HMDSO can be withdrawn at the bottom of the column through a drain line 23, controlled by way of a valve 24, and passed to a recovery installation (not shown here).

As indicated by the arrow 25′ an auxiliary gas can be fed into the top of the column 1 by way of the inlet line 25 if the admixing of a further gas component is wanted in the column 1. That inlet line 25 can also serve for flushing the column 1.

A thermoelement 26 is also shown at the top in the middle at the head of the column 1. The temperature of the gas in the column can be measured by means of the thermoelement 26.

A liquid sensor (not shown here) can also be provided at the bottom 20 of the column in order to sense whether and possibly how much unevaporated HMDSO has been formed at the bottom 20 of the column.

FIGS. 2 and 3 shows the column 1 in terms of its more specific construction with the filling packings 2 and the clamping rings 28 at the top and the bottom of the column 1. While FIG. 2 is similar to the embodiment shown in FIG. 1 and in that case liquid HMDSO is allowed to drip onto the filling bodies in comparatively large drops from the discharge end 4 of the feed connection portion 3 because the drops are substantially distributed in the filling bodies 2, the embodiment of FIG. 3 represents an additional auxiliary measure, more specifically a distributor bowl or cup 29 which is arranged substantially perpendicularly with respect to the vertical longitudinal centre line 5, that is to say horizontally, and which spans over the entire internal cross-section of the column 1. The distributor bowl 29 is disposed at a small spacing of between 0.1 and 10 mm and preferably at about 2 mm under the lower part of the inner discharge end 4 of the feed connection portion 3.

FIG. 4 shows a first embodiment of a distributor bowl 29 on an enlarged scale in a column 1 which is shown broken-away at top and bottom. The above-mentioned spacing of the distributor bowl from the inner discharge end 4 of the feed connection portion 3 is measured in the central region 30 of the distributor bowl for the vertical longitudinal centre line 5 extends through that central region 30 and touches substantially the lower part of the discharge end 4 of the feed connection portion 3. Disposed in the central region 30 of the distributor bowl 29 is a raised portion which is symmetrical with respect to the longitudinal centre line 5.

Another embodiment as shown in FIG. 5 also has such a raised portion 31 where it is provided with a central through hole 32. That through hole 32 is not to be found in FIG. 4. The raised portion 31 in the central region 30 of the distributor bowl 29 is solid in the case of the embodiment of FIG. 4 while in FIG. 5 it is produced in the form of a bent curved sheet.

In all three embodiments as shown in FIGS. 4 to 6 the distributor bowl 29 is of a circular cross-section which is adapted to the internal space in the column and which can be particularly clearly seen in the perspective views in FIGS. 5 and 6.

In all three embodiments shown herein the important thing in the distributor bowl 29 is the central tray or plate portion 33. In the example shown in FIG. 4 the central plate portion 33 is of a solid configuration, with the raised portion 31; in the example shown in FIG. 5 it is in the form of an upwardly curved sheet or plate with the central through hole 32; while in the case of FIG. 6 it is a flat sieve.

While in the sieve configuration shown in FIG. 6 through holes are distributed uniformly over the entire central plate portion 33 (possibly with exceptions in the edge region), wider through holes 34 are disposed at the edge of the circular central plate portion 33. The through holes 32 and 34 serve to allow the HMDSO which is supplied in liquid form through the feed flow connection 3 to drip therethrough. The HMDSO is already substantially finely divided by the distributor bowl 29 before passing into the filling body 2 therebeneath. The droplets of liquid, which are between one and two orders of magnitude smaller, in comparison with the large drops of liquid leaving the inner discharge end 4 of the feed connection portion 3, leave the distributor bowl 29 in the region of the central plate portion 33, distributed over same, in a substantially vertically downward direction, in order to pass into the filling body 2 and there be further distributed.

The central plate portion 33 is supported by a central ring element 35. The ring element 35 in turn is fixed at a spacing to an outer ring 37 by way of spokes 36 which are arranged radially and distributed uniformly at the periphery. The spacing between the outer ring 37 and the central ring element 35 provides a free annular area composed of four segments which represent gas through-flow openings 38.

In operation more specifically the HMDSO which is finely distributed in the filling bodies and partially evaporated must flow upwardly through the gas through-flow openings 38 through the distributor bowl 29 to the top of the column 1 so that the product gas mixture can then be fed to the consumer by way of the line 6.

List of references

| | |
|---|---|
| 1 | column |
| 2 | filling packings |
| 3 | feed connection portion |
| 3′ | flow direction |
| 4 | discharge end of the feed connection portion |
| 5 | longitudinal centre line of the column |
| 6 | gas outlet connection |
| 6′ | flow direction of the gas mixture |
| 7 | pressure regulator |
| 8 | valve |
| 9 | distribution system |
| 10 | distributor |
| 11 | introduction lines |
| 12 | bottles open at the top |
| 13 | cooling jacket |
| 14 | outlet of the cooling agent |
| 14′ | flow direction of the cooling agent |
| 15 | inlet |
| 15′ | flow direction |
| 16 | supply container |
| 17 | mass flow regulator |
| 18 | gas introduction line |
| 18′ | introduction direction for the carrier gas |
| 19 | mass flow regulator |
| 20 | bottom of the column |
| 21 | downstream end of the gas introduction line |
| 22 | cap |
| 23 | drain line |
| 24 | valve |
| 25 | inlet line |
| 25′ | flow direction |
| 26 | thermoelement |
| 27 | liquid sensor |
| 28 | clamping rings |
| 29 | distributor bowl |
| 30 | central region of the distributor bowl |
| 31 | raised portion |
| 32 | through hole |
| 33 | central plate portion |
| 34 | through holes |
| 35 | ring element |
| 36 | spokes |
| 37 | outer ring |
| 38 | gas through-flow openings |

1. Apparatus for producing a gas mixture of a liquid educt compound, for example HMDSO, and a carrier gas, for example oxygen (O₂), as a process gas, characterised in that a plurality of filling packings (2) are arranged in mutually superposed relationship in an elongate, substantially vertically arranged, coolable column (1), that fixed in the upper region of the column (1) are a feed connection portion (3) which is passed from the exterior into the column (1) and a gas outlet connection (6) which is passed outwardly, and that there are provided devices (7, 26) for measuring the temperature, the pressure and the amount of the issuing gas mixture.

2. Apparatus according to claim 1 characterised in that connected to the bottom (20) of the column (1) are a liquid sensor and a drain line (23), closable by a valve (24), for excess liquid.

3. Apparatus according to claim 1 or claim 2 characterised in that disposed under the inner discharge end (4) of the feed connection portion (3) is a distributor bowl (29) which spans over the cross-section of the column (1) and which has gas through-flow openings (38).

4. Apparatus according to one of claims 1 to 3 characterised in that arranged in the central region (30) of the distributor bowl (29) is a central plate portion (33) which is provided with through holes (34) and which is surrounded at the outside by the gas through-flow openings (38).

5. Apparatus according to one of claims 1 to 4 characterised in that the central plate portion (33) of the distributor bowl (29) is closed between the through holes (32, 34) and is supported by a central ring element (35).

6. Apparatus according to one of claims 1 to 4 characterised in that the central plate portion (33) is in the form of sieve plate and is supported by a central ring element (35).

7. Use of the apparatus (1) according to one of claims 1 to 6 for coating the internal surfaces of hollow bodies (12).
